(19) United States
(12) Patent Application Publication
(10) Pub. No.: US 2008/0279203 A1
(43) Pub. Date: Nov. 13, 2008

(54) Method of Operating a Node in a Communications Network

(75) Inventors: Jose Miguel Ramalho Ribeiro dos Santos, Lisboa (PT); Pedro Ricardo de Frias Rebelo Nunes, Linda-A-Velha (PT)

Correspondence Address: BELL, BOYD & LLOYD, LLP, P.O. BOX 1135, CHICAGO, IL, 60690, US

(73) Assignee: NOKIA SIEMENS NETWORKS GMBH & CO. KG

(21) Appl. No.: 11/795,618

(22) PCT Filed: Dec. 20, 2005
(86) PCT No.: PCT/EP2005/056987

§ 371 Date: Mar. 24, 2008

(30) Foreign Application Priority Data
Jan. 20, 2005 (GB) 0501131.7

(51) Int. Cl. H04L 12/56

(52) U.S. Cl. 370/406

(57) ABSTRACT

There is described a method of operating a node in a ring network. A first loop avoidance protocol, for example, a Spanning Tree Protocol (STP) is run at the node together with a protocol adaptation process. The protocol adaptation process performs processes that enable the first loop avoidance protocol to run over a second loop avoidance protocol, for example, the Ethernet Ring Protection Protocol (ERP), operating in the ring. This makes it easier for network operators to incorporate in networks running STP, equipment manufactured to run ERP.

The present invention relates to a method of operating a node in a communications network.

The Ethernet Ring Protection Protocol (ERPP), as described in U.S. Pat. No. 6,430,151, is network protection mechanism for Ethernet ring topologies. In a network operating ERPP, one of the ports of one of the nodes in the ring is blocked in order to keep the ring open to avoid unwanted loops. If a link failure is detected in the ring, the previously blocked port is unblocked so that an alternative ring path becomes available.

The Spanning Tree Protocol (STP) is a network protection mechanism that provides path redundancy while preventing undesirable loops in a network. STP is defined by IEEE in standard 802.1. To provide path redundancy, STP defines a tree that spans all switches in an extended network. STP places certain redundant data paths into a standby state by blocking traffic in certain ports. If one network segment becomes unreachable, the STP reconfigures the spanning tree topology and re-establishes the link by activating a standby path. All nodes in a Local Area Network (LAN) participating in STP obtain information on other nodes in the network through an exchange of data messages known as bridge protocol data units (BPDUs).

In metro networks, where ring topologies are common, ERP is an attractive option because after detection of a link failure, ERP assures a 50 ms recovery time. In a ring STP assures a recovery time of 2 s. ERP has the drawback of being applicable only to single ring networks. In more complex networks that have mixed topologies of meshes and rings, ERP cannot be used alone but must be used with STP. ERP and STP are protocols that operate in the same network layer (OSI layer-2) and both avoid loops by blocking traffic in certain ports. For this reason, it is not possible to combine the two protocols in the same equipment. This makes it difficult for network operators to incorporate in networks running STP, equipment manufactured to run ERP and hence benefit from ERP's short ring protection time.

AS STP and its variants do not run over ERP, the solution adopted to date to integrate STP and ERP equipment, has been to disable STP in all ports of a switch running ERP and to transport STP BPDUs transparently over the ERP ring. This approach results in STP aware equipment regarding ERP rings as being Local Area Networks. This has the disadvantage that if ERP becomes disabled or erroneous network configuration is performed, loop topologies in the network cannot be prevented.

The present invention aims to alleviate the above discussed problem.

According to the present invention there is provided a method of operating a node in a communications network, the method comprising: running at the node a first loop avoidance protocol; running at the node a protocol adaptation process that performs protocol adaptation processes to enable the first loop avoidance protocol to run over a second loop avoidance protocol operating in the network.

The above and further features of the invention are set forth with particularity in the appended claims and together with advantages thereof will become clearer from consideration of the following detailed description of an exemplary embodiment of the invention given with reference to the accompanying drawings, in which:

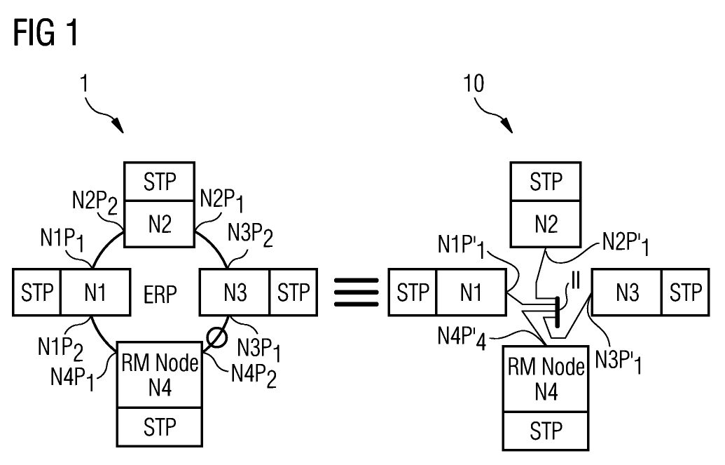

FIG. 1 illustrates a physical network embodying the network and a virtual network equivalent to the physical network;

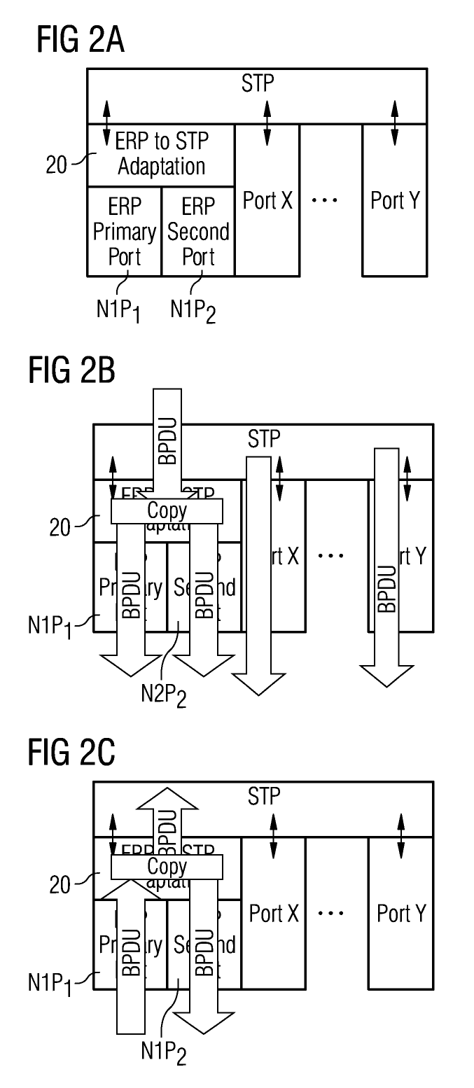

FIGS. 2a to 2c illustrates processes performed at a network node embodying the present invention;

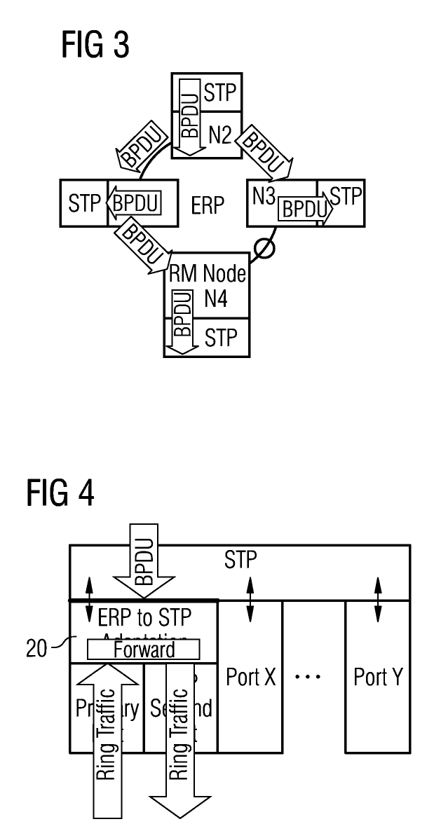

FIG. 3 illustrates the transmission of STP control messages in a ring network embodying the invention;

FIG. 4 illustrates processes performed at a network node embodying the present invention.

Embodiments of the invention allow STP to run over ERP to provide end-to-end protected networks in which all nodes are running STP. To achieve this, nodes in an ERP ring operate an ERP to STP port adaptation whereby a pair of ports at a ring node are presented to STP as a virtual single port belonging to a LAN.

The principle underpinning the invention is illustrated in FIG. 1. In FIG. 1, ERP ring network 1 comprises four nodes (N1, N2, N3, N4) arranged in the ring 1. Each of the nodes (N1, N2, N3, N4) comprises a pair of ports (N1_{P1}, N1_{P2}, N2_{P1}, N2_{P2}, N3_{P1}, N3_{P2}, N4_{P1}, N4_{P2},) one of which is connected via a link to a port of the next node in the ring and the other of which is connected via a link to a port of the previous node in the ring. The node N4 is a redundancy manager node of the type described in U.S. Pat. No. 6,430,151 that monitors the ring and reconfigures it if necessary. If no link errors occur in the ring the node N4 separates its port N4_{P2} and the port N3_{P1} of the node N3. If link errors do occur, the node N4 connects these ports together to provide an alternative path around the ring.

Each of the nodes (N1, N2, N3, N4) runs STP, but an ERP to STP adaptation process (not shown in FIG. 1) running at each of the nodes (N1, N2, N3, N4) masks the two ports of a node from the STP running at the node, presenting instead to the STP, a single virtual port belonging to a virtual LAN. In effect, the STP running at the nodes (N1, N2, N3, N4) is unaware of the actual physical lay out of the ring 1 shown in FIG. 1, but instead is aware of a logical lay out corresponding to the virtual LAN 10 also shown in FIG. 1. In this virtual network 10, each of the four nodes (N1, N2, N3, N4) has a single port (N1_{P1}′, N2_{P1}′, N3_{P1}′, N4_{P1}′) connected to a central hub 11.

The processes performed by an ERP to STP adaptation application 20 running at one of the nodes (N1, N2, N3, N4), say the node N1, are illustrated in FIGS. 2a to 2c. The ERP to STP adaptation application 20 runs between the STP and the first port (N1_{P1}) and the second port (N1_{P2}) of the node (N1). If during operation the STP sends a BPDU to the virtual port (N1_{P1}′ in FIG. 1), the ERP to STP adaptation application 20 receives the BPDU, copies it and using the same logical port ID, sends one of the BPDUs on the first port (N1_{P1}) and the other on the second port (N1_{P2}). (see FIG. 2b).

As illustrated in FIG. 2c, a BPDU received on one of the ports (N1_{P1} and N1_{P2}) of the Node (N1), in this example the first port (N1_{P1}), is copied and one of the BPDUs is sent to the STP and the other sent on the other port, in this example the second port (N1_{P1}) so that other nodes may also receive the BPDU. BPDUs received on any physical ERP port are thus seen by the STP as received by the single logical port.

Any of the four nodes N1 to N4 may be connected to other nodes which do not form part of the ring network. For simplicity no such other nodes are illustrated in FIG. 1, although in FIGS. 2a to 2c the ports through which the node N1 would communicate with any such other nodes are illustrated as Ports X to Y. As these nodes would not form part of a ring network with the node N1, Ports X to Y are controlled directly by the STP.

All of the nodes (N1, N2, N3, N4) in the ring network 1 operate in this fashion and so during operation all nodes will receive all BPDUs from every other node. This is illustrated in FIG. 3, which schematically shows how a BPDU originating from the STP of the node (N2) is transmitted to the other three nodes in the ring. The STP running at node N2 sends a BPDU and the ERP to STP adaptation application at N2 copies it and sends one of the BPDUs to the node N1 and the other to the node N3. At the node N1, the received BPDU is copied by the ERP to STP adaptation application and one of the BPDUs passed to the STP at the node N1 and the other sent to the node N4. At the node N3 the received BPDU is sent by the ERP to STP adaptation application to the STP running at the node. Likewise at the node N4. There is no transmission of a BPDU between the direct link between the nodes (N3) and (N4) because in this example this is the link that is blocked.

Thus since ERP guarantees that there are no loops in the ring, every node in the ring will receive a transmitted BPDU only once. Furthermore, ERP protection events are hidden from the STP which maintains the same logical topology.

All decisions taken by the STP regarding a logical port are taken for both physical ports that make up the virtual port. As an example, FIG. 4 illustrates a virtual port operating in a STP blocking state. In this state, the logical port is blocked so that the STP is prevented from sending traffic into the ring or from receiving traffic from the ring. However, ring traffic received on either of the physical ports is forwarded by the ERP to STP adaptation application on the other of the physical ports. As will be appreciated by those possessed of the appropriate skills, the virtual port may thus operate in any of the other STP states namely Learning, Listening, forwarding and disabling.

Although the specific embodiment described above is for adapting ERP to STP or its variants, other embodiments of the invention may hide any Medium Access Control (MAC) layer client protection protocol from STP and its variants. Thus, in embodiments of the invention ERPP, EAPS (described in U.S. Pat. No. 6,766,482) or other such protocols using any number of ports may be hidden from STP, Rapid STP (RSTP) or Multiple STP (MSTP) (IEEE 802.1D, 802.1s, 802.1w).

Having thus described the present invention by reference to preferred embodiments it is to be well understood that the embodiments in question are exemplary only and that modifications and variations such as will occur to those possessed of appropriate knowledge and skills may be made without departure from the scope of the invention as set forth in the appended claims.

1.-8. (canceled)

9. A method of operating a node in a communications network, the method comprising:
running at the node a first loop avoidance protocol; and
running at the node a protocol adaptation process to enable the first loop avoidance protocol to run over a second loop avoidance protocol operating in the network.

10. A method according to claim 9, wherein the network comprises a ring and the node comprises a pair of ports connected in the ring, the method further comprising:
operating the first loop avoidance protocol on a single port basis,
wherein the protocol adaptation process presents the pair of ring ports to the first loop avoidance protocol as being a single virtual port thereby enabling the second loop avoidance protocol to operate on a two port basis.

11. A method according to claim 10, wherein the first loop avoidance protocol is a spanning tree type protocol and the second loop avoidance protocol is a ring protection protocol.

12. A method according to claim 10,
wherein a control message, received at the node from the ring network over one of the pair of ports in accordance with the second loop avoidance protocol, is duplicated by the protocol adaptation process, and
wherein one of the messages is passed to the first loop avoidance protocol and the other of messages is transmitted into the ring over the other of the pair of ports in accordance with the second loop avoidance protocol.

13. A method according to claim 10,
wherein a control message generated by the first loop avoidance protocol is duplicated by the protocol adaptation process, and
wherein one of the messages is transmitted into the ring over a first one of the pair of ports and the other of the messages is transmitted into the ring over a second one of the pair of ports in accordance with the second loop avoidance protocol.

14. A method according to claim 13,
wherein a control message, received at the node from the ring network over one of the pair of ports in accordance with the second loop avoidance protocol, is duplicated by the protocol adaptation process, and
wherein one of the messages is passed to the first loop avoidance protocol and the other of messages is transmitted into the ring over the other of the pair of ports in accordance with the second loop avoidance protocol.

15. A method according to claim 14, wherein the first loop avoidance protocol is a spanning tree type protocol and the second loop avoidance protocol is a ring protection protocol.

16. A node in a network having a ring, comprising:
a processing unit;
a pair of ports connected in the ring;
a first loop avoidance protocol use by the node on a single port basis; and
a protocol adaptation process executing on the processing unit of the node to enable the first loop avoidance protocol to use over a second loop avoidance protocol operating in the network,
wherein the protocol adaptation process presents the pair of ring ports to the first loop avoidance protocol as being a single virtual port thereby enabling the second loop avoidance protocol to operate on a two port basis.

17. A computer program for operating a node in a communications network, the program stored on a medium readable by a processor unit and having instructions that are executable on the processor unit, the program when executed by the processor unit performs a method comprising:
running at the node a first loop avoidance protocol;
running at the node a protocol adaptation process to enable the first loop avoidance protocol to run over a second loop avoidance protocol operating in the network; and
operating the first loop avoidance protocol on a single port basis,
wherein the network comprises a ring and the node comprises a pair of ports connected in the ring,
wherein the protocol adaptation process presents the pair of ring ports to the first loop avoidance protocol as being a single virtual port thereby enabling the second loop avoidance protocol to operate on a two port basis, and
wherein the first loop avoidance protocol is a spanning tree type protocol and the second loop avoidance protocol is a ring protection protocol.
